(19) United States
(12) Patent Application Publication
(10) Pub. No.: US 2004/0252321 A1
(43) Pub. Date: Dec. 16, 2004

(54) Windowed mailer intermediate for reducing printer jamming

(76) Inventors: Roger D. Buck, Pittsburg, KS (US); Randy L. Allee, Fort Scott, KS (US)

Correspondence Address: WARD KRAFT, INC., P.O. BOX 338, FORT SCOTT, KS, 66701, US

(21) Appl. No.: 10/458,087

(22) Filed: Jun. 10, 2003

(51) Int. Cl. G06F 15/00

(52) U.S. Cl. 358/1.14; 358/1.6

(57) ABSTRACT

The present invention relates to a unique windowed mailer intermediate, suitable for use in self-sealing mailer applications, that has been found to reduce printer jamming, in non-impact printer, sealers, folders and other processing equipment. The windowed mailer intermediate of the present invention substantially eliminates interference with the printer mechanism that feeds the intermediate through the printing means through the use of a uniquely applied adhesive pattern.

### CROSS-REFERENCES TO RELATED APPLICATIONS

None.

### FIELD OF THE INVENTION

The present invention relates to a unique windowed mailer intermediate, suitable for use in self-sealing mailer applications, that has been found to reduce printer jamming, in non-impact printer, folders, sealers and other processing equipment. The windowed mailer intermediate of the present invention substantially eliminates interference with the printer mechanism that feeds the intermediate through the printing means through the use of a uniquely applied adhesive pattern.

The adhesive pattern secures the edges of the window patch or ply in such a manner that the material forming the window does not interfere with the processing of the mailer intermediate. The adhesive pattern is applied such that one of the end edges is coterminous with one of the end edges of a transparent or translucent ply. The other end edge of the adhesive pattern, stops short of the of die cut area of the window area so as to create an adhesive free zone or area so as to prevent contamination or blocking of the window area by the adhesive.

In related embodiments for the present invention, the adhesive pattern may also be provided with security indicia or provided or coated in a regular or pre-determined pattern that indicates tampering of the mailer or the contents of the mailer through the window. In addition, The transparent or translucent ply that makes up the window for the mailer intermediate may also be cut so as to provide a series of arcuate corner edges to facilitate feeding of the mailer through the printer.

### BACKGROUND OF THE INVENTION

Windowed envelopes are generally known in the stationery industry and are typically used to permit an address printed on an internal ply to be visible when the mailer is provided in a folded condition. The address is then visible through the die cut window so that the mailer may be delivered to the designated recipient.

Mailers such as the foregoing are suitable for use as business correspondence, personal letters, general communications, advertising pieces, direct mail solicitations, bill, remittance or the like. Their use is desirable in that such configurations permit the address to be viewed so that the United States Postal Service, courier service or other communication delivery means may deliver the mail piece or communication device to the intended recipient.

More recently, windowed self-mailers have been created wherein a cut sheet of material is printed and folded upon itself so that address information may be visible though one of the overlapping plies of the mailer. That is, the sheet of material is processed through a printer, impact, non-impact (laser printer, ink jet), and address information is printed or imaged in a predetermined area of the sheet. The printing may be done in a normal configuration or reverse font imaging. The sheet is then folded upon itself so that a previously die cut area is positioned over the address area so that the address area can be seen when the sheet of material is in a folded or overlaid condition.

Windowed mailers such as the foregoing suffer from several drawbacks. One such drawback is where a die cut is simply provided to permit the address indicia to be visible, there is no covering over the address indicia and the indicia can become obscured or with toner may flake off, making delivery difficult if not impossible. In addition, the imposition of a die cut without any protective covering can lead to undetected tampering, as the mailer can be intercepted, the internal information compromised or the address indicia changed or altered, thereby destroying the intended purpose of the communication. This can be particularly troublesome where the communication is used to carry personal information about the recipient.

One solution of this problem has been to apply a covering over the die cut area so as to protect the address indicia from obstruction or alternation. However, with the use of such windowed self-mailers, a number of difficulties have arisen. The application of a window film over a die cut area increases the thickness of the cut sheet when processing through laser printers. This can create a “bump” in the mailer and may cause imaging to be distorted as the imaging equipment rids over the bump and then resumes printing after settling down on the initial thickness. More typical problems associated with such window mailers is that the patch of material that is to become the covering for the die cut area that forms the window often has free end edges or exposed sides that can become folded over the ply creating an increased thickness. Such a situation interferes with the printing and further processing of the mailer. Moreover, the free sides or corners of the window ply material can catch on the internal processing of the mailer, thus causing the mailer to partially skew out of alignment which leads to the printing appearing in unintended areas, leading the user to dispose of the sheet of material.

In addition, to the foregoing identified problems, where adhesive has been used to hold the window film in position of the die cut area, the adhesive can creep or ooze into the area of the die cut. This adhesive ooze or creep causes the adhesive to contact the internal handling mechanisms of the printing equipment. This leads to jams as unwanted portions of the mailer become adhered to the internal printer handling mechanisms. Such a situation makes further processing of the mailer difficult if not impossible as the sheet of material may tear upon further processing or removal as portions of the mailer cling to the printer apparatus.

Another problem associated with prior art constructions is that the window on self-mailers may be removed so that the contents may be altered or otherwise compromised. This may be due to a number of deficiencies in current constructions. One such example relates to an ineffective sealing arrangement of the window ply to the mailer that permits the easy peeling away of the window without destroying the window. This makes tampering difficult to detect as the individual intercepting the mailer may be able to reposition the ply back over the window. Another problem with current constructions is that the ply may simply be removed without creating sufficient fiber tear and then replaced with another ply thereby concealing the act of tampering.

Typically, conventionally prepared window mailers, a die cut area having a patch covering the die cut, will normally have a loose end edge or edges that extend around the periphery of the window area. This loose area can extend outwardly from the edge of the adhesive by as much as a quarter of an inch but more usually up to about 1/16 of an inch. Such loose ends or edges can cause the mailer to be caught or jammed in the processing equipment which leads to down time of the processing system, destroyed product and frustration by the user of the product. Such prior constructions have been found to be even more difficult in the small or home office environment (“SOHO”) in that desktop laser printers may not be able to accommodate portions of a mailer that can rise up and interfere with the operation of the printer.

What is needed therefore is a window mailer that overcomes the foregoing drawbacks, yet be simple to use and inexpensive to produce, while maintaining the appearance of traditional windowed envelopes or mailer without substantially increasing the cost associated with such products.

### BRIEF SUMMARY OF THE INVENTION

The present invention relates to a unique window mailer that uses a ply of material (transparent, translucent, coated, or the like) that is sized and configured to fit over a die cut out area of a substrate or cut sheet material. The intermediate sheet material or substrate, in its final configuration is intended to be folded to create a communication piece. The intermediate has an adhesive pattern applied in a unique manner so that the edge of the window ply that forms the window for the mailer is coterminous with one edge of the adhesive pattern. In this instance, the edge perimeter of the ply used to create the window is thus not able to interfere with the feed mechanisms of the printer. In addition, the other perimeter edge of the adhesive pattern stops short of the edge of the die cut area so that adhesive does not ooze into the area of the window causing either distortion or blocking of the information that is to be visible through the window. Through prevention of oozing of the adhesive into the window area precludes separate panels of the mailer intermediate from adhering one to another.

In one embodiment of the present invention, a mailer intermediate is provided and includes a substrate that has first and second surfaces or faces (front and back of the substrate). The intermediate has longitudinally extending side edges and transversely extending end edges. The longitudinally extending side edges run parallel with one another and the transversely extending end edges run parallel with one another. The side edges are perpendicular to the end edges. The substrate is provided with a predetermined dimension that includes a length extending in a first direction and a width extending in a second direction distinct from the first direction. The length of the substrate is greater than the width of said substrate and the length is generally greater in the direction of the longitudinally extending side edges.

The intermediate of this embodiment also includes at least one die cut area having a dimension including a length extending in a first direction and a width extending in a second direction distinct from the first direction. The length of the die cut being greater than the width of the die cut area. The length dimension of the die cut area is perpendicular to the length dimension of the substrate and the width of said die cut area being perpendicular to the width of said substrate. A transparent, translucent or coated ply is disposed over the die cut area and the ply has a dimension that is larger than the dimension of the die cut area, by at least 5% and preferably greater than about 15% in each of the first and second directions.

The presently described summary embodiment is also provided with a pattern of adhesive that is disposed on the substrate in the area around the die cut. The pattern of adhesive has first and second perimeter edges. One of the perimeter edges, the outer perimeter edge, is coterminous with a perimeter edge of the ply (the outer perimeter edge) and the other of the perimeter edges (inner perimeter edge) of the adhesive pattern is disposed away from the perimeter of the die cut area. The inner perimeter edge of the adhesive pattern in each of the first and second directions is positioned a distance away from the perimeter edge of the die cut in an amount that is sufficient to create an adhesive free zone or an area devoid of adhesive. The transparent ply and pattern of adhesive are provided in a manner so as to create a window having fully sealed end edge perimeter that reduces printer-feeding problems that have commonly been associated with conventionally prepared windowed mailers.

In a further embodiment of the present invention a mail system for communicating for small and home offices is described and includes a printer means and a means for generating variable indicia and for communicating with the printer means. The communication means provides signals to print indicia on a receiving means via the printing means.

In this embodiment, the receiving means has a die cut area to be used as a window with the die cut area or window having a dimension made up of a length and width dimension. The window includes a transparent or translucent ply that is larger in size than the dimension of the die cut in each of the length and width dimension and is applied over the die cut area. The window is provided for viewing the printed indicia on a panel of the receiving means when prepared in a folded condition.

The receiving means has first and second surfaces or faces (front and back) and the printed indicia are provided on at least one of the first and second surfaces. The ply is disposed over the die cut area for the window and is secured to the receiving means via a predetermined adhesive pattern. The adhesive pattern has an adhesive free zone that is adjacent the dimension of the die cut area. The ply and the adhesive pattern form at least one perimeter sealed end edge to facilitate movement through the printing means. The ply and adhesive pattern cooperate for form an area devoid of adhesive which extends continuously around the outer perimeter of the die cut area.

The printing, communication and variable print generating means creating a communication piece that is suitable for delivery and useable through a small or home office.

In a still further embodiment of the present invention a windowed mailer intermediate is described for reducing jamming of internal printer handling mechanisms. The intermediate includes a substrate having first and second surfaces, at least one die cut area that has an outer perimeter with the perimeter having transversely extending end edges and longitudinally extending side edges. The side edges run parallel to one another and perpendicular to the end edges.

A transparent ply is disposed over the die cut area and extends beyond the outer perimeter of the die cut window along each of the longitudinally extending side edges and the transversely extending end edges.

An adhesive pattern for securing the transparent or translucent ply over the die cut area is also provided. The adhesive pattern extends beyond the outer perimeter of the die cut are along each of the transversely extending end edges and the longitudinally extending side edges. The adhesive area has an adhesive free area adjacent the outer perimeter of the die cut. An end edge forming an outer perimeter of the transparent ply and the outer perimeter of the adhesive area are coterminous such that the transparent ply and the adhesive area cooperate to form sealed end edges so as to reduce jamming in an office printer.

In a yet still further embodiment of the present invention a method for producing a windowed mailer intermediate for reduced printer jamming is described. The method includes the steps of, initially advancing a first web of material in a machine direction, with the first web of material having first and second faces and first and second longitudinally extending sides and first and second transversely extending end edges. The side edges run parallel to one another and the end edges run parallel to one another. The side edges are perpendicular to the end edges.

Next, in accordance with the presently described method, at least one regular, pre-determined area is cut in the first web. A second web is advanced in a machine direction so as to run in a parallel, overlapping arrangement with the first web. The second web is constructed from a laminate that includes a transparent or translucent substrate; a pattern of adhesive disposed on the substrate that is sized and configured in accordance with the die cut made in the first web; and a release layer supporting the substrate and pattern of adhesive.

The adhesive pattern carried by the second web is then applied and positioned around the pre-determined cut area in the first web. Then the release layer is removed from a portion of the second web so as to expose the adhesive pattern resting on the first web. The pattern of adhesive affixes the transparent or translucent substrate to the pre-determined cut area on the first web to form a window. The first web is then processed with the window on a printing means to include indicia at least related to a recipient and a sender.

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a front view of the windowed mailer intermediate;

FIG. 2 provides a cross section taken along line 2-2 of FIG. 1;

FIG. 3 shows a front elevation of the windowed intermediate;

FIG. 4, illustrates a schematic of the process used to create a laminate that is prepared in connection with forming the windowed mailer intermediate of the present invention;

FIG. 5 depicts a further schematic of the present invention illustrating the application of the laminate to the windowed mailer intermediate;

FIGS. 6 through 15 provide various adhesive patterns used in connection with the present invention; and

FIG. 16 provides a schematic diagram illustrating the use of the windowed mailer intermediate prepared in accordance with the present invention.

### DETAILED DESCRIPTION OF THE INVENTION

The present invention is now illustrated in greater detail by way of the following detailed description, but it should be understood that the present invention is not to be construed as being limited thereto.

The term “intermediate” as used herein refers to a product that undergoes one or more processing steps prior to the intermediate reaching a final condition, such as is suitable for mailing or delivery. The additional processing steps may include printing, imaging, folding, sealing, separating, cutting, perforating, scoring, adhering and the like. Typically, a product such as with the present invention is provided in an intermediate condition so that a customer can add or manipulate the intermediate to create the final or desired end product, such as a sealed self-mailer or a sealed communication piece for business or personal use.

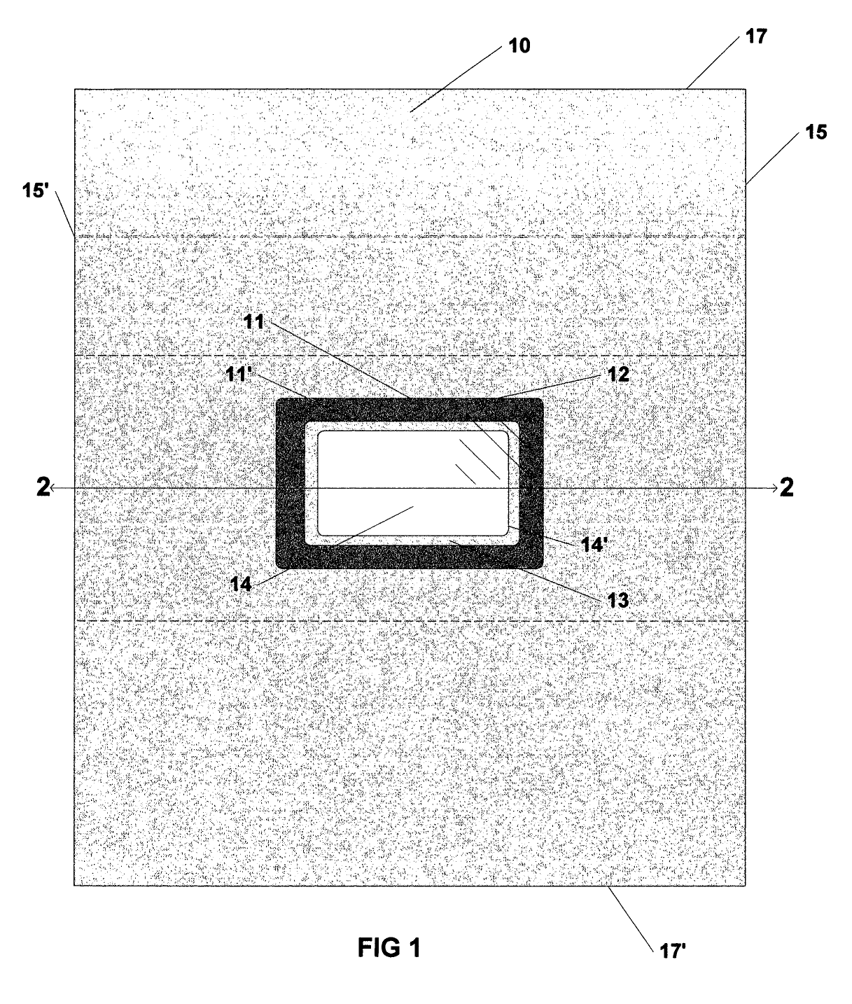

FIG. 1 illustrates the windowed mailer intermediate of the present invention. The mailer intermediate includes a substrate depicted by reference to numeral 10. The substrate 10 may be of any suitable material that is capable of receiving imaging and/or printed indicia, such as bond stock (paper 20 or 24 pound stock), plastic films (such as polyethylene based materials), tag or card stock (generally composed of cellulosic material) and the like. The substrate 10, as depicted in FIG. 1 may be divided into a plurality of panels through the use of lines of weakness such as score lines or perforations. By dividing the substrate 10 into one or more panels the substrate 10 may be folded upon itself to create an assembly that can be used for mailing or delivery once folded. If a single fold line is provided, for example medially of the cut sheet, the sheet would be folded onto itself to create a “V” fold mailer. If two fold or score lines are provided, the mailer could be folded into a “C” or “Z” folded mailer. The score lines dividing the panels need not be equal in dimension in order that “eccentric” mailers could be manufactured from the substrate.

In an alternative arrangement, it should be understood that the substrate 10 need not be folded an instead a second substrate may be applied over the surface of the substrate to create a secure mailer or delivery piece. In this configuration, the second substrate would be of equivalent size to the first substrate.

The substrate 10 is provided with first and second longitudinally extending side edges 15 and ′ and first and second transversely extending end edges 17 and 17′. As depicted in FIG. 1, the side edges are longer than the end edges, however, it should be understood that the edges and sides may be of equal length or alternatively the ends may be longer than the side edges. For the present embodiment, the side edges extend a distance greater than the end edges. Also as depicted, the side edges 15 and 15′ are parallel to one another as are end edges 17 and 17′. Side edges 15 and 15′ are perpendicular to end edges 17 and 17′.

The substrate 10 is provided with a cut out area generally designated by reference numeral 14. The cut out area or die cut 14 has a perimeter 14′ extending continuously around the edges. As illustrated in FIG. 1, the die cut 14 is centrally disposed within the substrate 10. However, it should be understood that the die cut 14 may be positioned in any portion of the substrate 10, in order to accommodate the particular configuration envisioned by the manufacturer or the end user. In addition, more than one die cut areas could be provided in the substrate. Such die cuts and may be used to create additional window areas which would permit a return address to show through or other indicia that the sender desires to illustrate such as a sweepstakes entry number, reservation number, expiration date of an offer and the like.

An adhesive pattern 12 is applied to the substrate 10 in an area around the die cut 14. The adhesive pattern 12 has an outer end edge 11 or an outer perimeter and an inner edge 11′ or an inner perimeter. The inner edge or perimeter 11′, as illustrated in FIG. 1, is shown spaced from the perimeter of the die cut 14′ to create an adhesive free area 13 or an zone devoid of any adhesive. This adhesive free zone or area 13 precludes the adhesive from oozing into the area of the die cut 14 and interfering with the printing apparatus handling mechanism or sealing to other adjacent plies. That is, if the adhesive is permitted to ooze into the die cut area 14, then the adhesive may cause one or more of the panels to bind to one another creating a mailer that is unusable. This may be due either to the mail or delivery piece not being capable of being opened properly or alternatively, the mailer is sealing improperly, the panels sticking together in an unexpected configuration.

Turning now to FIG. 2, a cross section of the invention taken along line 2-2 of FIG. 1. In FIG. 2, the substrate 10 is illustrated with the adhesive pattern 12 securing a transparent or translucent ply 16 over the die cut area 14. Adhesive free zone 13 shows that the adhesive does not encroach on the area of the die cut 14 so as to obscure information that would be intended to be visible through the window 16.

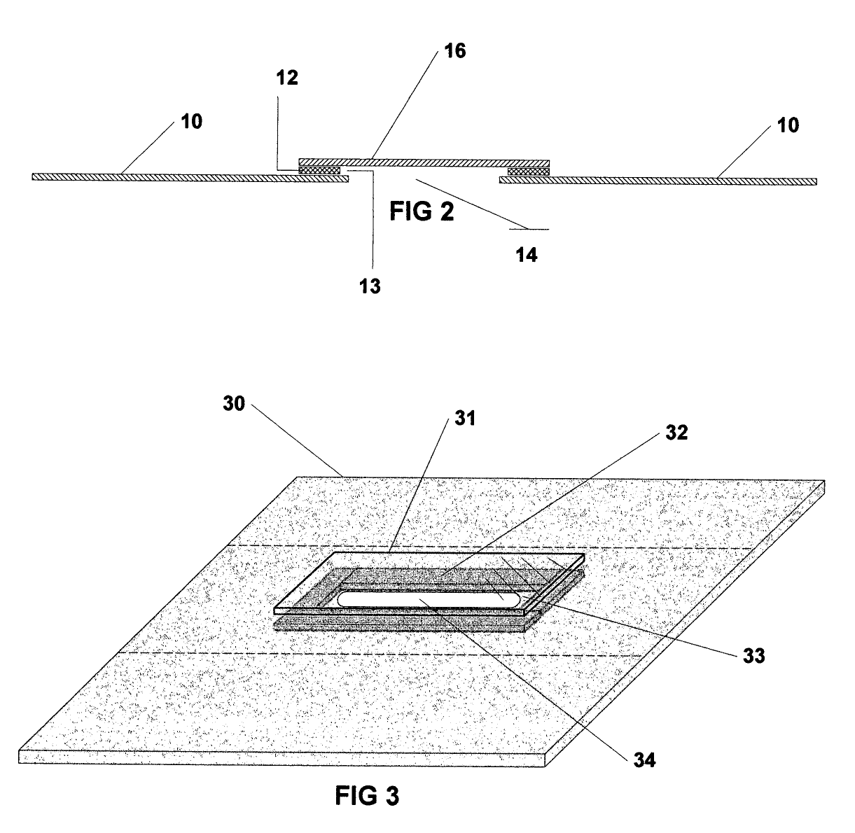

FIG. 3 provides an exploded view of the windowed mailer intermediate depicting the substrate 30 having a window provided therein. The window is created through use of a die cut area 34, adhesive pattern 32 with an adhesive free zone 33 adjacent a perimeter of the die cut area 34. A transparent or translucent ply 32 is then positioned over the top of the adhesive pattern in such a manner that the end edges or outer perimeter of the transparent or translucent ply 31 are completely sealed to the substrate. Those portions of the ply 31, which are disposed over the die cut area 34 and adhesive free zone 33, are not adhered to the substrate.

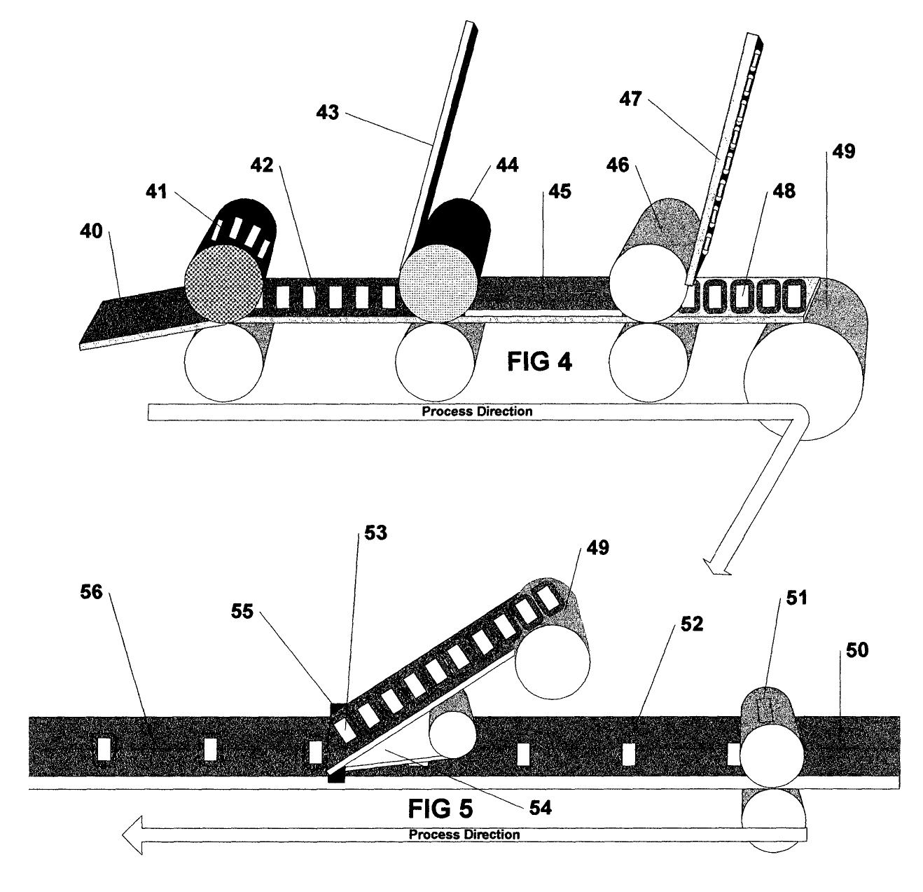

FIGS. 4 and 5 provide schematic representations of an exemplary method used in the manufacture of the present invention. Other methods of manufacture are possible, however for the purposes of the present exemplary embodiment, only the present method will be described.

Turning to FIG. 4, a first web of material 40 is fed in a machine direction. The web of material should be selected from any suitable material having transparent or translucent properties, for instance polyester based films, including glassine type material. The web 40 is first passed through a die cutting station 41, which cuts the material which will serve as the windows 42 for the mailer intermediate. The material to become the window ply may be cut in any intended geometric configuration, square, circular, star, rectangular or the like. For the present embodiment the window material is cut in a generally rectangular arrangement in which the corners of the cut area are arcuate or rounded.

The windows 42 that have been cut in the web 40 are then moved via the web 40 to an adhesive pattern application station depicted as reference numerals 44, 45, 46. The adhesive pattern is applied over the die cut window material 42 through the use of an adhesive transfer carrier, such as transfer tape or the like. The use of the terms adhesive transfer carrier refers to a web of material having an adhesive material which has a greater affinity for the material with which it is brought into contact than for the carrier web of material with which it is initially disposed.

The adhesive of the transfer material may have pre-designated areas with activated adhesive or comprise a combination of active and un-active areas (tacky to the touch and non-tacky areas) of the adhesive transfer material. That is, only certain portions of the transfer material, those portions having tacky or active adhesive will transfer or adhere to the die cut window material 42. As can be seen in FIG. 4, those portions of the transfer material that do not correspond to the window material 42 are then rewound on a conventional re-winder not shown. That is, the adhesive transfer matrix is rewound. The removed transfer material matrix would have those portions equal to the window removed while the remainder of the web is rewound.

In order to advance the webs of material so that adhesive pattern is in registry with the window material, the manufacturing device may be provided with one or more optical or other sensors (physical sensors) to detect the presence or absence of a die cut window. Alternatively, mechanical actuators may be used to advance the webs of the material in an incremental fashion. As the die cut window material enters the adhesive transfer station, the transfer station advances so as to apply the adhesive pattern over the die cut window material. Rollers 44 and 46 serve to advance the second web of adhesive transfer material 43 into position over the first web 40 as well as to bond the adhesive transfer pattern into alignment with the die cut window area 42.

After the adhesive pattern has been transferred to the die cut window area, web 40, now with both the die cut window area and adhesive pattern disposed thereon 48 are advanced to a further transfer station shown in FIG. 5.

As shown in FIG. 5, a third web designated by numeral 50 is advanced in a machine direction so as to be brought into association with the pre-configured window assembly 48 formed in the operation shown in FIG. 4. Web 50, which will form the mailer intermediate of the present invention, is selected from material suitable for receiving printing and/or imaging as well as one that is receptive to adhesive and acceptable for use as a correspondence or communication piece by the US Postal Service. Exemplary materials include bond paper stock, tag or card stock, Mylar® films and the like.

Web 50 is initially advanced to a die cutting station 51 where a window die cut 52 is cut into the web of material. The die cut 52 is smaller than the window/adhesive pattern patch 48 that is to be applied over the die cut 52. That is the window/adhesive patch 48 extends longer in length and width dimensions and is at least 5% longer in each of the length and width dimensions and preferably greater than 10% in each of the dimensions. The additional length and width dimensions are necessary in order to create the adhesive free zone or area around the perimeter of the die cut 52.

Web 50 after the die cutting operation performed at step 51 is then advance to the window patch 53 application station seen by reference to numeral 55. The window patch material 53 is fed so as to be in step-wise registry with the die cut 52 in web 50. As indicated previously, such registration may be accomplished by one or more sensors or through the use of mechanical actuators.

As the web 50 is advanced beneath window patch 53 application stage 55, the individual window patches 53 are applied over the top of the web and in registry with the die cut window areas 53. The widow patches 53 are applied such that the adhesive pattern does not come into contact or overlap with the perimeter of the die cut window. After the window patch 53 has been applied the web 56 is then advanced to be collected as part of a rolled product suitable for use with high speed printing applications or may be cut and sheeted as is typically required for SOHO type applications.

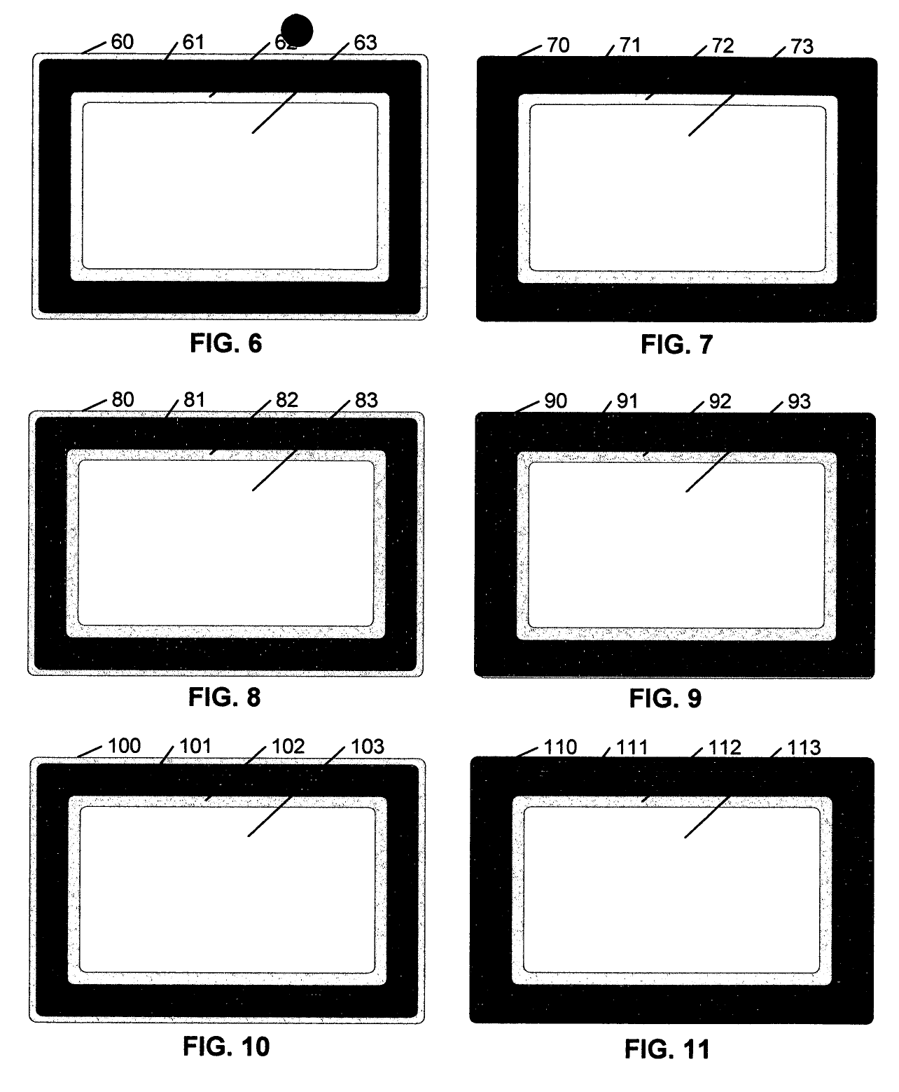

Turning now to FIGS. 6-15, a plurality of adhesive patterns are illustrated for use with the present invention. Reference numerals 60, 70, 80, 90, 100, 110, 120, 130, 140 and 150 refer to the outer perimeter of the combination of window material and adhesive pattern. As is seen in FIGS. 6, 8, 10, 12 and 14, an adhesive free zone is provided adjacent the outer end edge of the window ply material. The window material extends outwardly not greater than 10% of the total length or width dimension of the adhesive pattern. In FIGS. 7, 9, 11, 13 and 15, the outer perimeters of the adhesive pattern and window material are coterminous with one another.

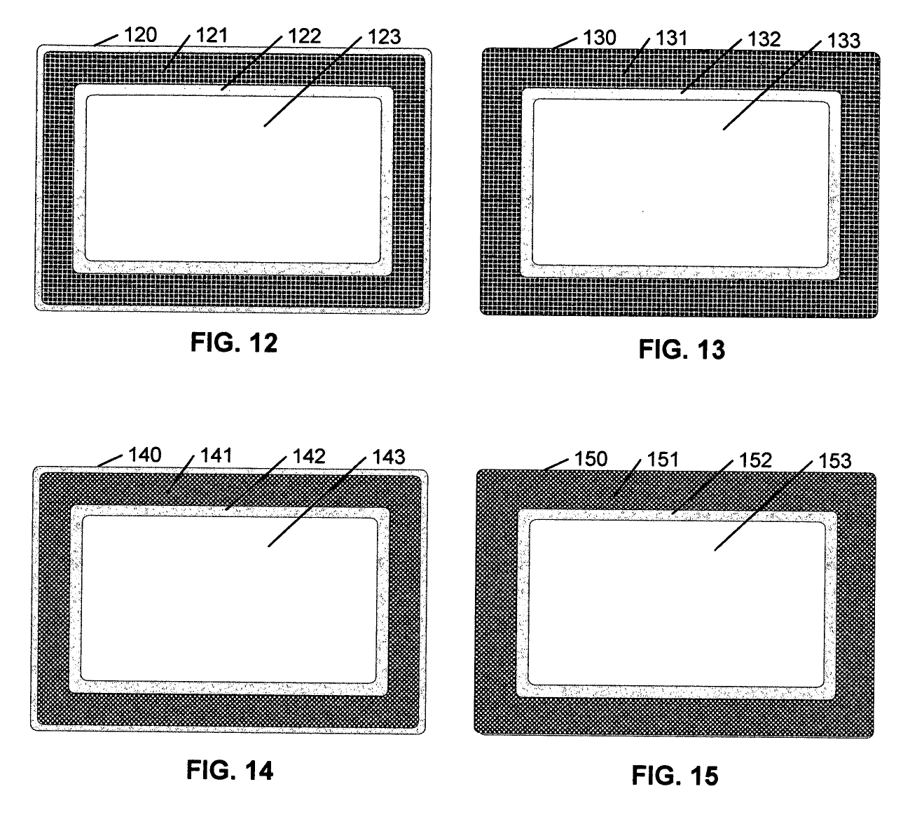

Still referring to FIGS. 6-15, reference numerals 61, 71, 81, 91, 101, 111, 121, 131, 141 and 151 illustrate the various types of adhesive patterns that may be used in connection with the present invention. The adhesive patterns shown in FIGS. 6-11 are generally depicted as striations extending vertically, horizontally and diagonally, while the patterns illustrated in FIGS. 12-15 are provided in interlocking striations that form crossed or squared patterns.

The patterns 61, 71, 81, 91, 101, 111, 121, 131, 141 and have been found to be advantageous for several reasons. In a first instance, the adhesive if in a molten state will enable the adhesive to flow into the uncoated areas, channels or striations thereby reducing adhesive ooze into undesirable areas. In a second application the fine patterns produced by the present invention are useful in detecting tampering or unauthorized removal of the window material. That is, upon removal of the window material, the pattern and striations are disrupted and it is difficult to reapply adhesive so that the striations or channels are once again completely visible.

Reference numerals 62, 72, 82, 92, 102, 112, 122, 132, 142 and 152 designate the adhesive free zone between the inner perimeter of the adhesive pattern and the outer perimeter of the die cut formed in the sheet material. This region that is devoid of adhesive prevent adhesive from oozing onto or into the area of the die cut so as not to obscure the address or other indicia intended to be visible through the window depicted as reference numerals 63 73, 83, 93, 103, 113, 123, 133, 143 and 153.

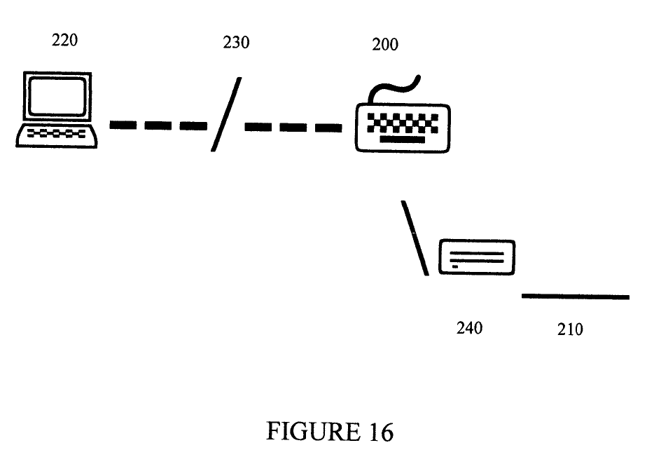

With respect to FIG. 16, a brief schematic is provided to illustrate use of the present invention in a small or home office (“SOHO”) environment. A printing means 200, such as a desktop laser or ink jet printer is provided for processing a receiving means 210. The receiving means is the mailer intermediate of the present invention. The system is provided with a means for generating variable indicia 220, which may include a desktop computer, or a preprogrammed data base or data set that generates indicia in response to various commands or signals. The variable print generating device 220 is connected to the printing means 200 through a communication means 230. The communication means 230 may include a telephone connection or connection over a global communications network, so that the printing of the mailer intermediate may be accomplished at a remote location. Alternatively, the printing may be accomplished a single desktop location.

After the printing means 200 receives a signal from the means for generating variable indicia 220 via the communication means 230, the receiving means 210 is printed and imaged and then passed to a processing stage 240 where the mailer intermediate is folded, sealed or otherwise acted upon in order to place the communication device with the US Postal Service or courier delivery means.

It will thus be seen according to the present invention a highly advantageous windowed mailer intermediate has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A mailer intermediate, comprising;
a substrate having first and second surfaces, first and second longitudinally extending side edges and first and second transversely extending end edges, said substrate having a dimension including a length extending in a first direction and a width extending in a second direction distinct from said first direction and said length of said substrate being greater than said length of said substrate;
a die cut area having a dimension including a length extending in a first direction and a width extending in a second direction distinct from said first direction and said length of said die cut being greater than said width of said die cut area;
said length dimension of said die cut area being perpendicular to said length dimension of said substrate and said width of said die cut area being perpendicular to said width of said substrate;
a transparent or translucent ply disposed over said die cut area and said ply having a dimension that is larger than said dimension of said die cut area in each of said first and second directions;
a pattern of adhesive disposed on said substrate around said die cut area, said pattern of adhesive having first and second edges, one of said first and second edges being coterminous with an edge of said ply and another of said first and second edges disposed away from said dimension of said die cut area in each of said first and second directions a distance sufficient to create an adhesive free zone; and
wherein said transparent ply and said pattern of adhesive are provided in a manner so as to create a window having sealed end edges that reduce printer feeding problems.

2. A mailer intermediate as recited in claim 1, wherein said pattern of adhesive is provided with a series of striations.

3. A mailer intermediate as recited in claim 1, wherein said pattern of adhesive is provided with a series of interlocking striations.

4. A mailer intermediate as recited in claim 1, wherein said dimension of said ply is at least 5% greater than said dimension of said die cut in each of said first and second directions.

5. A mailer intermediate as recited in claim 1, wherein said ply is provided with arcuate comers.

6. A mail communicating system for small and home offices, comprising;
a printing means;
a means for generating variable indicia;
a means for communicating between said printer means and said means for generating variable indicia, said means for communicating providing signals through said means for generating variable indicia to print indicia on a receiving means via said printing means;
said receiving means having a window, said window having a die cut area that has a dimension and a transparent or translucent ply that is larger than said dimension and is applied over said die cut area, said window being provided for viewing printed indicia created by said printing means, said receiving means having first and second surfaces and said printed indicia being provided on at least one of said first and second surfaces;
said ply is disposed over said die cut area for said window and is secured to said receiving means via an adhesive pattern, said adhesive pattern having an adhesive free zone that is adjacent said dimension; and
wherein said receiving means with said printing means, said variable print generating means and said communicating means creating a physically deliverable communication piece for a small or home office.

7. A mail communicating system for small and home offices as recited in claim 6, wherein said printing means and said means for generating variable indicia are at remote locations.

8. A mail communicating system for small and home offices as recited in claim 6, wherein said printing means and said means for generating variable indicia are at a single location.

9. A mail communicating system for small and home offices as recited in claim 6, wherein said communication means is a global communications network.

10. A windowed mailer intermediate for reducing printer jamming, comprising;
a substrate having first and second surfaces;
a die cut area having a perimeter, said perimeter having transversely extending end edges and longitudinally extending side edges;
a transparent ply disposed over said die cut area and extending beyond said perimeter along each of said transversely extending end edges and said longitudinally extending side edges;
an adhesive pattern for securing said transparent ply over said die cut area, said adhesive pattern extending beyond said perimeter along each of said transversely extending end edges and said longitudinally extending side edges and having an adhesive area and an adhesive free area adjacent said perimeter; and
wherein an end edge of said transparent ply and said adhesive area being coterminous and said transparent ply and said adhesive area having sealed end edges to reduce jamming in an office printer.

11. A windowed mailer intermediate for reducing printer jamming as recited in claim 10, wherein said ply is at least 5% greater than said dimension of said die cut along each of said longitudinally extending sides and said transversely extending end edges.

12. A windowed mailer intermediate for reducing printer jamming as recited in claim 10, wherein said ply is provided with arcuate comers.

13. A method for producing a windowed mailer intermediate having reduced printer jamming, comprising the steps of;
advancing a first web of material in a machine direction;
cutting regular pre-determined areas in said first web;
advancing a second web, said second web comprising a laminate including;
a pattern of adhesive; and
a release layer disposed on said second web and supporting said pattern of
adhesive; said second web, said pattern of adhesive and said release layer
forming a laminate;
advancing a third web, said third web being composed of a different material from said second web and said third web being capable of receiving print or images and adhesive;
cutting regular pre-determined areas in said third web;
positioning said laminate with said adhesive pattern around said pre-determined cut areas in said third web;
affixing said pattern of adhesive with said transparent or translucent substrate to said pre-determined cut area in said third web to form a window; and
processing said third web with said window to include indicia related to a recipient and a sender.
